(19) United States
(12) Patent Application Publication
(10) Pub. No.: US 2010/0179996 A1
(43) Pub. Date: Jul. 15, 2010

(54) MULTI-MESSAGE TRIGGERED SUBSCRIPTION NOTIFICATIONS

(75) Inventors: Gareth E. Jones, Winchester (GB); Darren M. Shaw, Fareham (GB)

Correspondence Address: SCULLY, SCOTT, MURPHY & PRESSER, P.C., 400 GARDEN CITY PLAZA, SUITE 300, GARDEN CITY, NY, 11530, US

(73) Assignee: INTERNATIONAL BUSINESS MACHINES CORPORATION, Armonk, NY (US)

(21) Appl. No.: 12/352,747

(22) Filed: Jan. 13, 2009

(51) Int. Cl. G06F 15/16

(52) U.S. Cl. 709/206

(57) ABSTRACT

A publisher, a subscriber or a message broker sets a messaging engine in the message broker to send or forward one or more messages to subscriber(s) after receiving a specific number of messages on specific topic(s) within a specific time interval. A plurality of publishers publishes messages on the specific topic(s). A messaging engine receives the published messages. If the number of the published messages on the specific topic(s) becomes the specific number of messages within a specific time interval, the messaging engine sends or forwards a single or plural message(s) on the specific topic to the subscriber(s). Otherwise, the messaging engine does not send or forward any message on the specific topic to the subscriber(s).

### BACKGROUND OF THE INVENTION

1. Fields of the Invention

The present invention relates to publish/subscribe messaging system. More particularly, the present invention relates to sending a message to subscriber(s) after receiving a specific number of messages within a specific time interval.

2. Description of the Prior Art

A publish/subscribe is an asynchronous messaging mechanism where message senders (i.e., publisher or publishing client) do not send messages to specific receivers (i.e., subscriber or subscribing client). In a publish/subscribe network, any number of consumers (i.e., subscribers) of information can receive messages that are provided by one or more producers (i.e., publishers) of that information. In this case, a producer of information is called a publisher and a consumer of that information is called a subscriber.

Publish/subscribe messaging provides the concept of a topic on which any number of interested consumers of information can subscribe in order to register their interest. This is similar to the way that a person might subscribe only to magazines about topics in which they are interested. Each topic provides particular event or state information.

A publisher can send messages containing information about a particular topic to all subscribers to that topic, without any knowledge of how many subscribers there are, or the details of the nodes that host those subscribers. Because of this, publish/subscribe messaging completely decouples the provider of the information from the consumer of that information.

In order to facilitate this publish/subscribe capability, a broker device is required to hold information about which subscribers have subscribed to which topics and how to deliver messages to them. A publisher can then publish messages using the broker device to all subscribers on that topic without knowing the details of those subscribers. There can be multiple publishers for a particular topic, and a subscriber to information about one topic can also be a publisher of information about other topics.

The broker device is a component to which clients (i.e., applications or systems) connect to perform publish and subscribe messages. The broker device handles a matching of publications with subscriptions, a distribution of publications to subscribing clients, and a persistence (i.e., storing messages in a non-volatile storage) of messages to ensure message delivery at a quality of service required. The broker device acts as a hub for routing messages between clients and other messaging servers. The broker device can store messages on behalf of a client that is not connected and make them available to the client when it reconnects.

Thus, in a traditional publish/subscribe messaging system, if a publisher publishes a message on a topic, then any subscribers to that topic will receive that message. However, there may be a situation where the traditional publish/subscribe messaging system is not suitable. For example, consider a scenario in which a secure door must be opened by a use of two keys turned at a same time. If this scenario is applied in a publish/subscribe messaging system, a subscriber (opening the door) may receive two published messages (generated when the two keys are turned) and have to (1) know that the two keys are needed to open the secure door and (2) determine that the two keys are both turned at a same time.

Another example where the traditional publish/subscribe messaging system is not suitable may be a system used to detect swarms of insects in a field. Assume that there is an array of motion sensors spread over the field. Each sensor may be highly sensitive, but low powered and thus has a small coverage range (e.g., less than 10 ft). The sensors are arranged in a tree shaped topology, passing messages through nodes to a main controller at a root of the tree. To detect a swarm covering a large portion of the field, each node in the tree only passes messages upward if the node receives 10 messages from below node(s) at an approximately same time (e.g., within 10 seconds). Receiving 10 messages at the approximately same time may indicate the swarm of insects, rather than an individual or an isolated group of them. If sensors are structured like this (i.e., tree shaped topology), when a swarm of insects passes through the field, a lot of messages (e.g., 1000 messages) may be generated and overload the main controller collecting the messages. However, when a traditional publisher/subscribe messaging system is applied on these sensors described above, each node in the tree (i.e., a subscriber receiving messages published by nearby sensors) must (1) know that 10 messages constitute a local swarm and (2) determine that 10 sensors publishes each message at a same time.

Thus, in these two examples, subscribers need to know whether a specific number of messages are generated by publishers and need to know whether the specific number of messages is generated at a same time. Hence, it is desirable that a method and/or system prevent the publishers and the subscribers from knowing whether the publishers generated the specific number of messages for a topic within the specific time interval. It is desirable to enable the method and/or system to transfer a message to subscriber(s) when publishers generate a specific number of messages for a topic within a specific time interval.

### SUMMARY OF THE INVENTION

The present invention describes a method and system for sending a message to subscriber(s) when publisher(s) generate a specific number of messages for a topic within a specific time interval. The publisher(s) and subscriber(s) may not know whether the publisher(s) generated the specific number of messages for the topic within the specific time interval.

In one embodiment, there is provided a method for sending a message in a publish/subscribe messaging system, the method comprising:

specifying in a message broker a number of messages and a time interval;

receiving, at the message broker, the specified number of messages within the specified time interval from publishers, the specified number of messages being related to a topic; and

sending, at the message broker, a message to subscribers, after receiving the specified number of messages within the specific time interval.

In one embodiment, there is provided a system for sending a message in a publish/subscribe messaging system, the system comprising:

means for specifying a number of messages and a time interval;

means for receiving the specified number of messages within the specified time interval from publishers, the specified number of messages being related to a topic; and

means for sending a message to subscribers, after receiving the specified number of messages within the specific time interval.

In a further embodiment, the message is a first message received among the specified number of messages.

In a further embodiment, the message is a last message received among the specified number of messages.

In a further embodiment, the message represents details of the specified number of messages.

### BRIEF DESCRIPTION OF THE DRAWINGS

The accompanying drawings are included to provide a further understanding of the present invention, and are incorporated in and constitute a part of this specification. The drawings illustrate embodiments of the invention and, together with the description, serve to explain the principles of the invention. In the drawings,

FIG. 1 illustrates a system diagram according to one embodiment of the present invention.

FIG. 2 illustrates a flow chart including method steps employed according to one embodiment of the present invention.

FIG. 3 illustrates hardware configuration implementing one embodiment of the present invention.

### DETAILED DESCRIPTION

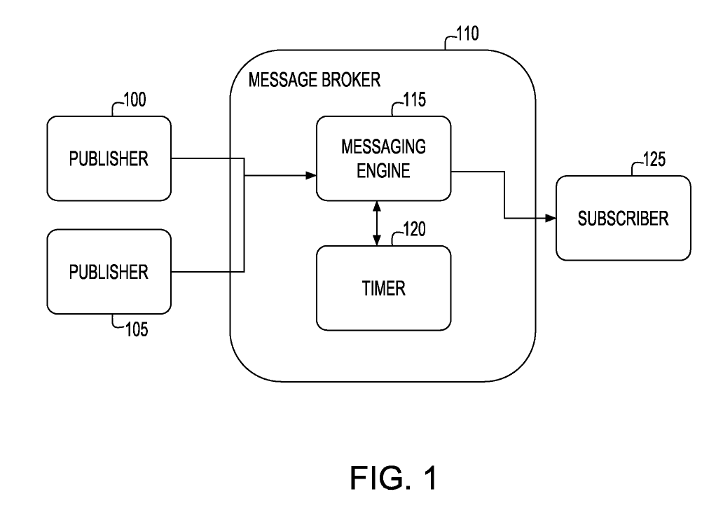

One embodiment of the present invention implements a system (e.g., a message broker 110 in FIG. 1) operating in a publish/subscribe messaging system for a plurality of messages to result in a single action (e.g., transmitting a single message to subscriber(s)) while hiding this functionality (e.g., receiving the plurality of messages from publisher(s) and transmitting a single message to subscriber(s)) from both the publisher(s) and subscriber(s). For a specific topic, the system may deliver one or more messages to subscribers if the system receives a specific number of messages (e.g., 10 messages) within a specific time interval (e.g., 1 hr). For example, when ten messages are published within one hour for a topic, the system delivers a single message (e.g., one of the ten messages) to subscriber(s). Otherwise, the system does not deliver any message to the subscriber(s), who subscribe messages for the topic.

FIG. 1 illustrates a system diagram according to one embodiment of the present invention. A plurality of publishers (e.g., publishers 100, 105) publishes a plurality of messages for a plurality of topics. One or more message broker (e.g., a message broker 110) receives the published messages and delivers them to a plurality of subscribers (e.g., a subscriber 125). A publisher may a computing device such as a laptop computer, a desktop computer, a workstation, a mainframe, etc.. A subscriber may also be a computing device such as a laptop computer, a desktop computer, a workstation, a mainframe, etc.. In one embodiment, a publisher may be any application publishing a message for a topic. A subscriber may be any application subscribing a message for a topic.

In one embodiment, a message broker (e.g., a message broker 110) includes a messaging engine 115 and a timer component 120. The messaging engine may be a messaging middleware such as Java Message Service (JMS) and IBM® WebSpere MQ®. Java Message Service (JMS) is a messaging standard that allows applications based on Java® technology to create, send, receive and read messages. The JMS enables distributed, loosely coupled, reliable and asynchronous communication between a publisher and a subscriber. IBM® WebSphere MQ® is an IBM® product allowing independent and non-concurrent applications on a distributed system to communicate each other. A timer component 120 measures a current time and/or an elapsed time between two events.

In one embodiment, a publisher 100 or 105, a subscriber 125 or a message broker 110 set a specific number of messages, a specific time interval and a specific topic in a messaging engine 115 in the message broker 110, e.g., via an API (Application Programming Interface) call or a function call such as “set (topics, numberOfMessages, timeInterval)”, which is a method call for setting the specific number of messages, the specific time interval and the specific topic in the messaging engine 115. After setting the specific number of messages, the specific time interval and the specific topic in the messaging engine 115, if the message engine 115 receives the specific number of messages for the specific topic within the specific time interval from one or more publishers, the message engine 115 in the message broker 110 sends a single message on the specific topic to one or more subscribers. Otherwise, the message engine 115 does not send any message on the specific topic to the one or more subscribers.

In a further embodiment, the single message sent by the message engine 115 is the first message received for the specific topic within the specific time interval.

In a further embodiment, the single message sent by the message engine 115 is the last message received fro the specific topic within the specific time interval.

In a further embodiment, the single message sent by the message engine 115 is a new message representing details or contents of all the specific number of messages.

In a further embodiment, each publisher has a unique client ID (identification). To ensure that the messaging engine 115 receives messages from each different publisher for a topic within a time interval, the messaging engine 115 checks a client ID of a publisher of each message whenever the messaging engine 115 receives each message. If the messaging engine 115 receives more than one message from a publisher for a topic within a time interval, the message engine 115 considers theses messages as duplicated messages and considers them as one message.

In a further embodiment, every message in a specific topic has a specific message header or identical payload. A message header may include, but is not limited to, a unique message ID (identification), a topic ID (identification), and tracking information detailing a path the message took. A payload refers to an actual data in the message. For example, if a message is 100 bytes and a message header is 20 bytes, a payload of the message is 80 bytes (100 bytes-20 bytes). To ensure that the specific number of messages are all related to the specific topic, the messaging engine 115 verifies that the specific number of messages include a specific message header such as a same topic ID. Alternatively, the messaging engine 115 may verifies that the specific number of messages have all same payload (i.e., same actual data size).

In a further embodiment, publishers and subscribers does not know whether the messaging engine 115 needs to receive the specific number of messages for the specific topic within the specific time interval to send one or more messages on the specific topic to the subscribers. The publishers and subscriber may not know how many messages the publishers generated for a topic for a time interval. It may be unknown to the publishers and the subscribers that the messaging engine 115 sends the single message to the subscribers after receiving the specific number of messages for the specific topic within the specific time interval.

In one embodiment, the message engine 115 sends all the specific number of messages to the one or more subscribers, after receiving the specific number of messages on the specific topic within the specific time interval.

In one embodiment, the specific numbers of messages are related to one or more topics. Thus, the message engine 115 sends one or more messages to one or more subscribers, if the message engine 115 receives the specific number of messages associated with the one or more topics within the specific time interval. Otherwise, the message engine 115 does not send any message associated with the one or more topics to any subscriber.

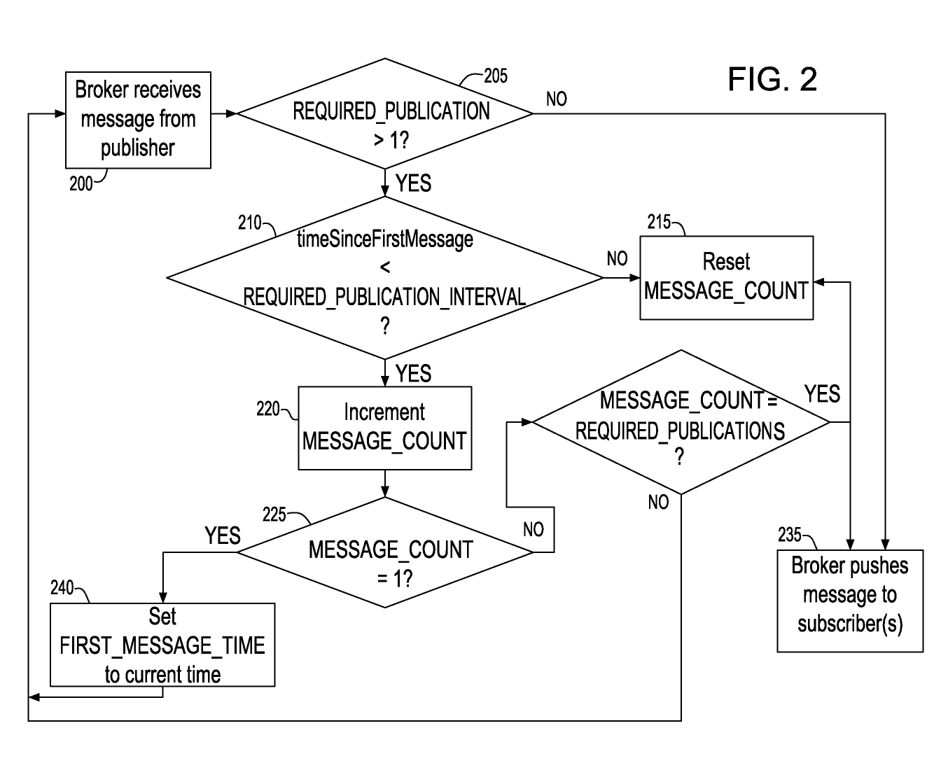

FIG. 2 illustrates a flow chart including method steps that the message broker 110 executes. Followings are definitions of terms used in the flow chart:
REQUIRED_PUBLICATIONS: the number of messages that must be published on a topic before a message on the topic is delivered to at least one subscriber.
REQUIRED_PUBLICATIONS_INTERVAL: a time allowed between message publications during which the published messages are considered as if they occurred at the same time.
MESSAGE_COUNT: the number of messages received for the topic since the first message on the topic is received.
FIRST_MESSAGE_TIME: a time when the first message on the topic is received at the broker.
timeSinceFirstMessage: an elapsed time between the FIRST_MESSAGE_TIME and a current time.
   In one embodiment, the REQUIRED_PUBLICATIONS and the
REQUIRED_PUBLICATIONS_INTERVAL are properties or attributes of a topic. The REQUIRED_PUBLICATIONS and the REQUIRED_PUBLICATIONS_INTERVAL may be stored in the broker 110 like following table 1:

TABLE 1
Topic Attributes

| Topic | | REQUIRED_PUBLICA- | |
|---|---|---|---|
| ID | REQUIRED_PUBLICATIONS | TIONS_INTERVAL | |
| 1 | 10 | 1 | hour |
| 2 | 20 | 30 | minutes |
| 11 | 1 | 0 | minute |

For example, for a topic whose topic ID is 1, the REQUIRED_PUBLICATIONS is 10 and the REQUIRED_PUBLICATIONS_INTERVAL is 1 hr. This means that for the topic whose ID is 1, the messaging engine 115 sends a message on the topic to subscriber(s) if the messaging engine 115 receives 10 messages from different publishers within 1 hour. Otherwise, the messaging engine 115 does not send or forward any message on the topic to the subscriber(s).

Initially, the messaging engine 115 in the message broker 110 sets the MESSAGE_COUNT and FIRST_MESSAGE_TIME to zero. At step 200, the messaging engine 115 receives a new message from a publisher (e.g., a publisher 100 or 105). Upon receiving the new message, at step 205, the messaging engine 115 checks the REQUIRED_PUBLICATIONS associated with a topic of the new message. If the REQUIRED_PUBLICATIONS associated with the new message is equal to 1 or 0 (e.g., Topic ID 11 in Table 1), the messaging engine 115 sends or forwards the new message to subscribers who subscribing the topic of the new message. Otherwise, the messaging engine 115 communicates with the timer component 120 to calculate the timeSinceFirstMessage. For example, the messaging engine 115 obtains a current time from the timer component 120 and then subtracts the FirstMessageTime from the current time to obtain the timeSinceFirstMessage, i.e., timeSinceFirstMessage=the current time−the FirstMessageTime.

At step 210, the messaging engine 115 compares the calculated timeSinceFirstMessage and the REQUIRED_PUBLICATIONS_INTERVAL. At step 215, if the calculated timeSinceFirstMessage is larger than or equal to the REQUIRED_PUBLICATIONS_INTERVAL, i.e., if the new message is received at the messaging engine 115 after the REQUIRED_PUBLICATIONS_INTERVAL since the first message is received at the messaging engine 115, then the messaging engine 115 reset the MESSAGE_COUNT to zero and does not send or forward any message on the topic associated with the new message. Otherwise, at step 220, the messaging engine 115 increase the MESSAGE_COUNT by 1, i.e., MESSAGE_COUNT=MESSAGE_COUNT+1.

At step 225, the messaging engine 115 evaluates whether the MESSAGE_COUNT is equal to 1, i.e., whether the new message is the first message received on the topic. If the MESSAGE_COUNT is equal to 1, the messaging engine 115 sets the FirstMessageTime to the current time, which is obtained from the timer component 120. Then, the control goes back to the step 200 to receive additional messages on the topic from other publishers. If the MESSAGE_COUNT is larger than 1, at step 230, the messaging engine 115 evaluates whether the MESSAGE_COUNT is equal to the REQUIRED_PUBLICATIONS, i.e., whether the messaging engine 115 received the REQUIRED_PUBLICATIONS for the topic within the REQUIRED_PUBLICATIONS_INTERVAL. If the MESSAGE_COUNT is equal to the REQUIRED_PUBLICATIONS, at step 235, the messaging engine 115 sends or forwards one or more messages on the topic to subscriber(s). At the same time, at step 215, the messaging engine 115 reset the MESSAGE_COUNT to zero. If the MESSAGE_COUNT is less than REQUIRED_PUBLICATIONS, the control goes back to the step 200 to receive additional message(s) on the topic.

Following describes an exemplary pseudo-code implementing the flow chart in FIG. 2.

messageCount = 0;
firstMessageTime = 0;
while (messageEngineIsRunning) {

message = getMessage( );

if (message) {

if (REQUIRED_PUBLICATIONS > 1) {

timeSinceFirstMessage=getTimeNow( )−firstMessageTime;
if(timeSinceFirstMessage<REQUIRED_PUBLICATIONS_INTERVAL){

messageCount++;
if (messageCount == 1){

firstMessageTime = getTimeNow( );

```
  }
  else if (messageCount==REQUIRED_PUBLICATIONS) {
```

sendMessageToSubscribers(message);
messageCount = 0;

}

}
else {

messageCount = 0;

}
}
else {

sendMessageToSubscribers (message);

}

}

}

By implementing this pseudo-code in the messaging engine 115, an administrator of the messaging engine 115 may allow a subscriber to only be notified of a published message when a set number of messages have been published within a set time interval.

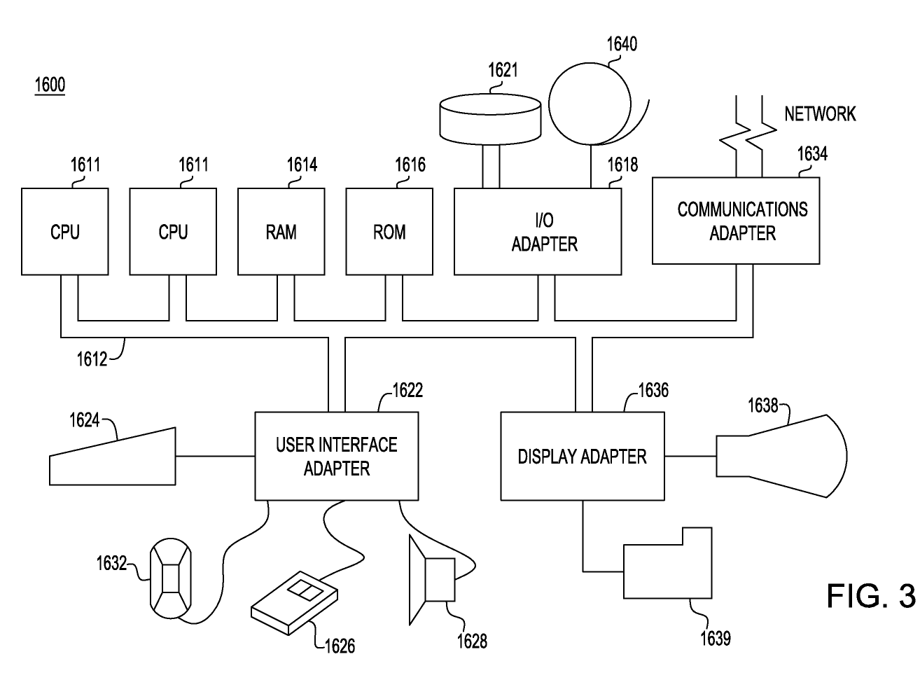

FIG. 3 illustrates a hardware configuration of a computing system 1600 (e.g., the message broker 110) executing the method steps in FIG. 2. The hardware configuration preferably has at least one processor or central processing unit (CPU) 1611.

The CPUs 1611 are interconnected via a system bus 1612 to a random access memory (RAM) 1614, read-only memory (ROM) 1616, input/output (I/O) adapter 1618 (for connecting peripheral devices such as disk units 1621 and tape drives 1640 to the bus 1612), user interface adapter 1622 (for connecting a keyboard 1624, mouse 1626, speaker 1628, microphone 1632, and/or other user interface device to the bus 1612), a communication adapter 1634 for connecting the system 1600 to a data processing network, the Internet, an Intranet, a personal area network (PAN), etc., and a display adapter 1636 for connecting the bus 1612 to a display device 1638 and/or printer 1639 (e.g., a digital printer of the like).

In a further embodiment, the message broker 110 including the messaging engine 115 and the timer component 120 is implemented as hardware on a reconfigurable hardware, e.g., FPGA (Field Programmable Gate Array) or CPLD (Complex Programmable Logic Device, using a hardware description language (Verilog, VHDL, Handel-C, or System C). In another embodiment, the message broker 110 is implemented on a semiconductor chip, e.g., ASIC (Application-Specific Integrated Circuit), using a semi custom design methodology, i.e., designing a chip using standard cells and a hardware description language.

In a further embodiment, the message broker 110 including the messaging engine 115 and the timer component 120 is implemented as software using one or more programming languages, e.g., C, C++, Java, .NET, Perl, Python, etc.. In one embodiment, the message broker 110 is recorded in a computer readable medium, e.g., CD (Compact Disc), DVD (Digital Versatile Disc), HDD (Hard Disk Drive), SSD (Solid State Drive), as an instruction, e.g., a machine language or assembly language, that is executed by a processor, e.g., Intel® Core®, IBM® Power PC®, AMD® Opteron®.

In a further embodiment, the message broker 110 including the messaging engine 115 and the timer component 120 is implemented as hardware through a computing device, e.g., a desktop, a laptop, a mainframe, a workstation, etc., by being executed in the computing device. The computing device comprises, but not limited to include, processor(s), memory(s), display device(s), input/output device(s) and network interface(s).

Although the embodiments of the present invention have been described in detail, it should be understood that various changes and substitutions can be made therein without departing from spirit and scope of the inventions as defined by the appended claims. Variations described for the present invention can be realized in any combination desirable for each particular application. Thus particular limitations, and/or embodiment enhancements described herein, which may have particular advantages to a particular application need not be used for all applications. Also, not all limitations need be implemented in methods, systems and/or apparatus including one or more concepts of the present invention.

The present invention can be realized in hardware, software, or a combination of hardware and software. A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which—when loaded in a computer system—is able to carry out these methods.

Computer program means or computer program in the present context include any expression, in any language, code or notation, of a set of instructions intended to cause a system having an information processing capability to perform a particular function either directly or after conversion to another language, code or notation, and/or reproduction in a different material form.

Thus the invention includes an article of manufacture which comprises a computer usable medium having computer readable program code means embodied therein for causing a function described above. The computer readable program code means in the article of manufacture comprises computer readable program code means for causing a computer to effect the steps of a method of this invention. Similarly, the present invention may be implemented as a computer program product comprising a computer usable medium having computer readable program code means embodied therein for causing a function described above. The computer readable program code means in the computer program product comprising computer readable program code means for causing a computer to effect one or more functions of this invention. Furthermore, the present invention may be implemented as a program storage device readable by machine, tangibly embodying a program of instructions executable by the machine to perform method steps for causing one or more functions of this invention.

The present invention may be implemented as a computer readable medium (e.g., a compact disc, a magnetic disk, a hard disk, an optical disk, solid state drive, digital versatile disc) embodying program computer instructions (e.g., C, C++, Java, Assembly languages, .Net, Binary code) executed by a processor (e.g., Intel® Core™2, IBM® PowerPC®) for causing a computer to perform method steps of this invention. The present invention may include a method of deploying a computer program product including a program of instructions in a computer readable medium for one or more functions of this invention, wherein, when the program of instructions is executed by a processor, the compute program product performs the one or more of functions of this invention.

It is noted that the foregoing has outlined some of the more pertinent objects and embodiments of the present invention. This invention may be used for many applications. Thus, although the description is made for particular arrangements and methods, the intent and concept of the invention is suitable and applicable to other arrangements and applications. It will be clear to those skilled in the art that modifications to the disclosed embodiments can be effected without departing from the spirit and scope of the invention. The described embodiments ought to be construed to be merely illustrative of some of the more prominent features and applications of the invention. Other beneficial results can be realized by applying the disclosed invention in a different manner or modifying the invention in ways known to those familiar with the art.

What is claimed is:

1. A method for sending a message in a publish/subscribe messaging system, the method comprising:
specifying in a message broker a number of messages and a time interval;
receiving, at the message broker, the specified number of messages within the specified time interval from publishers, the specified number of messages being related to a topic; and
sending, at the message broker, a message to subscribers, after receiving the specified number of messages within the specific time interval.

2. The method according to claim 1, wherein the message is a first message received among the specified number of messages.

3. The method according to claim 1, wherein the message is a last message received among the specified number of messages.

4. The method according to claim 1, wherein the message represents details of the specified number of messages.

5. The method according to claim 1, further comprising:
sending the specified number of messages to the subscribers after the specified time interval.

6. The method according to claim 1, wherein the specified number of messages are related to one or more topics.

7. The method according to claim 1, wherein the subscribers decides the specified number of messages, the specified time interval and the topic.

8. The method according to claim 1, wherein the publishers are each different.

9. The method according to claim 1, wherein the specified number of messages have a specific message header.

10. The method according to claim 1, wherein the specified number of messages have an identical payload.

11. The method according to claim 1, wherein it is unknown to the publishers and the subscribers that the message is sent to the subscribers after receiving the specified number of messages for the topic within the specified time interval.

12. A system for sending a message in a publish/subscribe messaging system, the system comprising:
means for specifying a number of messages and a time interval;
means for receiving the specified number of messages within the specified time interval from publishers, the specified number of messages being related to a topic; and
means for sending a message to subscribers, after receiving the specified number of messages within the specific time interval.

13. The system according to claim 12, wherein the message is a first message received among the specified number of messages.

14. The system according to claim 12, wherein the message is a last message received among the specified number of messages.

15. The system according to claim 12, wherein the message represents details of the specified number of messages.

16. The system according to claim 12, further comprising:
sending the specified number of messages to the subscribers after the specified time interval.

17. The system according to claim 12, wherein the specified number of messages are related to one or more topics.

18. The system according to claim 12, wherein the subscribers decides the specified number of messages, the specified time interval and the topic.

19. The system according to claim 12, wherein the publishers are each different.

20. The system according to claim 12, wherein the specified number of messages have a specific message header.

21. The system according to claim 12, wherein the specified number of messages have an identical payload.

22. The system according to claim 12, wherein it is unknown to the publishers and the subscribers that the message is sent to the subscribers after receiving the specified number of messages for the topic within the specified time interval.

23. A computer readable medium embodying computer program instructions being executed by a processor for causing a computer to perform method steps for sending a message in a publish/subscribe messaging system, said method steps comprising the steps of claim 1.

24. A method of deploying a computer program product including programs of instructions in a computer readable medium for sending a message in a publish/subscribe messaging system, wherein, when the programs of instructions are executed by at least one processor, the computer program product performs the steps of claim 1.
